(19) United States
(12) Patent Application Publication
(10) Pub. No.: US 2009/0034402 A1
(43) Pub. Date: Feb. 5, 2009

(54) Optical Head Device, Optical Information Device, Optical Disc Player, Car Navigation System, Optical Disc Recorder, and Optical Disc Server

(76) Inventors: Kanji Wakabayashi, Kyoto (JP); Yoshiaki Komma, Osaka (JP); Kousei Sano, Osaka (JP); Hidenori Wada, Kyoto (JP); Keiichi Matsuzaki, Osaka (JP); Toshiyasu Tanaka, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/280,699

(22) PCT Filed: Feb. 27, 2007
(86) PCT No.: PCT/JP2007/053628

§ 371 Date: Aug. 26, 2008

(30) Foreign Application Priority Data
Feb. 28, 2006 (JP) 2006-052610

(51) Int. Cl. G11B 7/00

(52) U.S. Cl. 369/112.24; G9B/7

(57) ABSTRACT

In an optical head device including a light source for emitting a light of a predetermined wavelength; a collimator lens for converting a divergence degree of the light; a folding mirror for folding a direction of the light emitted from the light source; an objective lens for converging the light on a recording surface of an optical disc; a photodetector for receiving the light reflected at the recording surface of the optical disc, and converting to an electric signal; and an optical path adjustment unit for guiding the light emitted from the light source to the collimator lens and guiding the light reflected at the recording surface of the optical disc to the photodetector; a wavelength plate for polarizing the light reflected by the folding mirror is arranged on an actuator base between the folding mirror and the objective lens.

### TECHNICAL FIELD

The present invention relates to an optical information device for reproducing information from an information recording medium as typified by an optical disc or recording information on the information recording medium, an optical head device for reproducing or recording information in the optical information device, an optical information device using the optical head device, and an optical disc player, a car navigation system, an optical disc recorder, and an optical disc server using the optical information device.

### BACKGROUND ART

A digital versatile disc (DVD) is known as an optical disc capable of recording large volume of data as it can record digital information at a recording density of about six times that of a compact disc (CD). In recent years, optical discs of larger volume are being demanded with increase in the amount of information to be recorded. In order to increase the volume of the optical disc, the recording density of the information needs to be increased, and an optical spot formed by a light irradiated on the optical disc when recording the information on the high density disc and when reproducing the information recorded on the optical disc needs to be made small. The optical spot can be made small by having the laser light of a light source to a short wavelength and increasing the numerical aperture (NA) of an objective lens. Nowadays, a light source having a wavelength of 660 nm and an objective lens having a numerical aperture (NA) of 0.6 are used in the DVD, but a recording density of five times the recording density of the current DVD can be achieved by using a blue laser having a wavelength of 405 nm and an objective lens of NA 0.85.

In an optical information device for realizing a high density recordation and reproduction using the laser of short wavelength by the blue laser, provision of a compatible function with the existing optical disc enhances usability as a device and leads to enhancement in cost performance. In this case, it is difficult to extend the operating distance as in the objective lens for DVD and CD while increasing the numerical aperture of the objective lens to 0.85, and thus two objective lenses, the objective lens used to record and reproduce the CD or the DVD and the objective lens for high density recording having a higher numerical aperture, are desirably arranged in a compatible optical information device capable of performing high density recordation and reproduction.

Generally, an objective lens actuator for the optical information device needs to be driven in both focusing and tracking directions, and a circuit therefor is arranged. This circuit has a function of maintaining the distance between the optical disc and the objective lens at a constant distance in the focusing direction, and moving the objective lens to a desired track position in the tracking direction. However, an objective lens corresponding to each of a plurality of optical discs having different recording densities is required in the optical information device that compatibly uses the plurality of optical discs having different recording densities, and thus the objective lens actuator needs to be configured with a plurality of objective lenses mounted on a movable unit and so as to be movable in the focusing and the tracking direction.

An optical head device having the plurality of objective lenses respectively mounted on the movable unit to realize a compatible optical information device capable of performing recordation and reproduction with respect to the plurality of optical discs having different recording densities is disclosed in Japanese Laid-Open Patent Publication No. 2002-208173.

FIG. 10 is a view showing a schematic configuration of an optical system of the optical head device disclosed in Japanese Laid-Open Patent Publication No. 2002-208173. In this optical head device, a light beam 61 radiated from a first light source (not shown) is converted to a substantially parallel light by a collimator lens 62 and has an optical axis folded in a direction perpendicular to an optical disc 65 having high recording density by a rising mirror 63 of flat plate shape. An objective lens 64 converges the light beam 61 on a recording surface of the optical disc 65. A light beam 66 radiated from a second light source (not shown) is converted to a substantially parallel light by a collimator lens 67 and has an optical axis folded in a direction perpendicular to an optical disc 70 having low recording density by a rising mirror 68 of flat plate shape. An objective lens 70 converges the light beam 66 on a recording surface of the optical disc 70.

An objective lens driving device (objective lens actuator) 71 is configured to hold the first objective lens 64 and to be movable in both directions of a focusing direction F orthogonal to the recording surface of the optical disc 65 having high recording density and a tracking direction T of the optical disc. An objective lens driving device (objective lens actuator) 72 is configured to hold the second objective lens 69 and to be movable in both directions of the focusing direction F orthogonal to the recording surface of the optical disc 65 having low recording density and the tracking direction T of the optical disc.

A configuration of mounting two objective lenses on a single objective lens actuator, and simultaneously moving the two objective lenses is disclosed in Japanese Laid-Open Patent Publication No. 11-120587 and Japanese Laid-Open Patent Publication No. 2005-293686.

As shown in FIG. 11, the device includes a CD, DVD optical system, and a high density optical disc optical system. The CD, DVD optical system includes a DVD module 85 in which a red semiconductor laser (second light source) light emitted when performing recordation/reproduction of information on the DVD to emit a laser light flux (second light flux) of 658 nm and a photodetector are integrated, and a CD module 83 in which an infrared semiconductor laser (third light source) light emitted when performing recordation/reproduction of information on the CD to emit a laser light flux (third light flux) of 785 nm and a photodetector are integrated. The lights emitted from the modules 83, 85 are respectively passed through a DVD collimator lens 86 and a CD collimator lens 84, and have the optical paths bent by polarization beam splitter 89, 87 so as to reach a rising mirror 88. The light is transmitted to an optical disc (not shown) from a second objective lens 81 common to the DVD/CD. The light reflected at the recording surface of the optical disc passes the same optical path, and reaches the DVD module 85 or the CD module 83.

In the high density optical disc optical system, a blue-violet semiconductor laser 73 (first light source) emits a laser light flux (first light flux) of 405 nm for performing recordation/reproduction of information on the high density optical disc. The laser light flux (first light flux) pass through a high density optical collimator lens 74 and has the optical path bent by a high density optical polarization beam splitter 75 so as to reach the rising mirror 88. The light is transmitted to an optical disc (not shown) from the first objective lens 80 for high density optical disc. The light reflected at the recording surface of the optical disc transmits through the polarization beam splitter 75 and reaches a photodetector 76 for high density optical disc.

A holding member 79 for holding the two objective lenses 80, 81 is held by a wire 82, and is configured to be movable in both directions of the focusing direction F orthogonal to the recording surface and the tracking direction T of the optical disc.
Patent document 1: Japanese Laid-Open Patent Publication No. 2002-208173
Patent document 2: Japanese Laid-Open Patent Publication No. 11-120587
Patent document 3: Japanese Laid-Open Patent Publication No. 2005-293686

### DISCLOSURE OF THE INVENTION

### Problems to be Solved by the Invention

In the configuration having the plurality of light sources and the objective lenses on a single optical head device, numerous members need to be incorporated in a small device, and thus the important matter lies on how to compactly arrange each member. In the next-generation high density optical disc, in particular, the recording layer may be configured to three layers or four layers, where spherical aberration correction and coma aberration correction are desirably performed over a wide range to accurately read the optical disc of multi-layer structure. Therefore, the correction range of the collimator lens is desirably large.

In the above configuration, however, the mounting space is small since the collimator lens is mounted between the light source and the polarization beam splitter, and the movement range of the collimator lens is limited. If a large movement range of the collimator lens is to be ensured, the optical head device itself enlarges.

In the high density optical disc optical system, the light source and the photodetector 76 are arranged at different positions without being united, and thus the optical paths need to be differed for the forward path light emitted from the light source and the backward path light reflected at the recording surface of the optical disc. As shown in FIG. 12, a configuration of inserting a wavelength plate 77 between the rising mirror 88 and the collimator lens 74 is adopted. In such configuration, the accommodating space of the collimator lens 74 is further reduced due to the wavelength plate 77, and the movement range of the collimator lens 74 is further limited.

Therefore, the technical problem to be solved by the present invention is, in an aim of solving the above problems, to provide a compact optical head device capable of increasing the movement range of the collimator lens and accurately performing the spherical aberration correction, an optical information device, and an optical disc player, a car navigation system, an optical disc recorder, and an optical disc server using the optical information device.

The present invention provides an optical head device having the following configuration to solve such technical problem.

According to the first aspect of the invention, there is provided an optical head device comprising:

a light source for emitting a light of a predetermined wavelength;

a collimator lens for changing a divergence degree of the light emitted from the light source;

a folding mirror for folding a direction of the light emitted from the light source which divergence degree is changed by the collimator lens;

an objective lens for converging the light folded by the folding mirror on a recording surface of an optical disc;

a photodetector for receiving the light converged on the recording surface of the optical disc by the objective lens and reflected at the recording surface of the optical disc, and converting to an electric signal;

a wavelength plate, arranged between the folding mirror and the objective lens, for polarizing the light reflected by the folding mirror; and

an optical path adjustment unit for guiding the light emitted from the light source to the collimator lens and guiding the light reflected at the recording surface of the optical disc to the photodetector according to the polarization of the light transmitted through the wavelength plate; the optical head device further comprising:

an optical base for holding the light source, the collimator lens, the folding mirror, and the photodetector;

an actuator base, arranged adjacent to the optical base, for holding the wavelength plate so as to cover an opening through which the light reflected by the folding mirror transmits, and

a suspension unit, supported to be movable in an optical axis direction of the objective lens and a track direction of the optical disc with respect to the actuator base, for holding the objective lens at a position enabling the light reflected by the folding mirror to reach the objective lens.

According to the second aspect of the invention, there is provided the optical head device according to the first aspect, wherein

the optical path adjustment unit is configured by a polarization beam splitter, arranged between the light source and the collimator lens, for polarizing the light emitted from the light source; and

the wavelength plate is configured by a λ/4 plate for polarizing the light reflected by the folding mirror to a circular polarized light.

According to the third aspect of the invention, there is provided the optical head device according to the first aspect, wherein the actuator base includes a fixed part, arranged projecting towards the optical base side, for fixing the wavelength plate.

According to the fourth aspect of the invention, there is provided the optical head device according to the third aspect, wherein the fixed part fixes the wavelength plate so as to be tilted at an angle of one to ten degrees with respect to the actuator base.

According to the fifth aspect of the invention, there is provided the optical head device according to the first aspect, wherein the suspension unit includes a suspension holder fixed to the actuator base, and a movable body for holding the objective lens, the movable body being supported by a suspension wire extending from the suspension holder and driven by a signal provided through the suspension wire.

According to the sixth aspect of the invention, there is provided the optical head device according to the first aspect wherein the light source is a semiconductor laser which emits light in a blue wavelength region

According to the seventh aspect of the invention, there is provided an optical information device comprising:

the optical head device according to any one of the first aspect to sixth aspect;

a motor for rotating the optical disc; and

an electric circuit for receiving a signal obtained from the optical head device, and controlling and driving the motor and the optical head device based on the signal.

According to the eighth aspect of the invention, there is provided a computer comprising:

the optical information device according to the seventh aspect;

an input device for inputting information;

a calculation device for performing calculation based on information input from the input device and information reproduced from the optical information device; and

an output device for displaying or outputting information reproduced by the optical information device and result calculated by the calculation device.

According to the ninth aspect of the invention, there is provided an optical disc player comprising:

the optical information device according to the seventh aspect; and

an information-image decoder for converting an information signal obtained from the optical information device to an image.

According to the tenth aspect of the invention, there is provided a car navigation system comprising:

the optical information device according to the seventh aspect; and

an information-image decoder for converting an information signal obtained from the optical information device to an image.

According to the eleventh aspect of the invention, there is provided an optical disc recorder comprising:

the optical information device according to the seventh aspect; and

an image-information encoder for converting image information to information to be recorded by the optical information device.

According to the twelfth aspect of the invention, there is provided an optical disc server comprising:

the optical information device according to seventh aspect; and

an input/output terminal for transmitting and receiving information with outside.

### EFFECT OF THE INVENTION

According to the first aspect of the present invention, the wavelength plate is arranged between the folding mirror and the objective lens and other members do not exist from the optical path adjustment unit to the folding mirror, and thus the movement range of the collimator lens can be extended over the entire distance between the folding mirror and the objective lens at a maximum. Therefore, the spherical aberration correction can be accurately carried out without enlarging the configuration of the optical head device.

The optical base can be made small by having the actuator base hold the wavelength plate. The wavelength plate is fixed since the wavelength plate is not arranged in the movable body, which wavelength plate does not influence the light beam by the movement of the movable body.

According to the second aspect of the present invention, the light emitted from the light source reliably reaches the optical disc, and the light reflected at the recording surface of the optical disc is guided to the photodetector with a simple configuration.

According to the third aspect of the present invention, the wavelength plate does not influence the movement range of the movable body when moving the movable body in the focusing direction orthogonal to the recording surface of the optical disc, and a large movement range of the movable body can be ensured.

According to the fourth aspect of the present invention, one part of the light reflected by the folding mirror is reflected at the surface of the wavelength plate and passed through the same optical path as the light emitted from the light source, and thus may influence the reading of the information. This problem can be prevented by tilting the wavelength plate. If such tilt becomes greater than or equal to 10 degrees, the distance between the objective lens and the folding mirror needs to be longer. If smaller than one degree, it is within the tilt range of when fixing the actuator base to the optical base in time of skew adjustment of the objective lens. As a result, the wavelength plate has a possibility of being arranged orthogonal to the optical path.

According to the fifth aspect of the present invention, the movable body is supported by the suspension wire, and thus the signal for driving the movable body is provided through the suspension wire and the members necessary for movement control and support of the movable body can be shared.

According to the sixth aspect of the present invention, it is suitably used as a head device used in the optical disc of next generation for performing reading and writing of information using blue laser light. This optical disc has a small optical spot and is formed to high density, and also includes a plurality of recording surfaces. Even when such optical disc is used, the movement range of the collimator lens can be made large and the spherical aberration can be corrected in a wider range.

An optical information device of a seventh aspect can be suitably used in various devices such as computer, optical disc player, car navigation system, optical disc recorder, optical disc server and the like.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a perspective view showing an outer appearance configuration of an optical pickup according to an embodiment of the present invention;

FIG. 2 is an exploded perspective view of the optical pickup of FIG. 1;

FIG. 3 is a schematic view showing in frame format a configuration of an optical system of the optical head device of FIG. 1;

FIG. 4 is a view showing an internal configuration of an optical base used in the optical head device of FIG. 1;

FIG. 5A is a plan view showing a configuration of an objective lens actuator of the optical head device of FIG. 1;

FIG. 5B is a cross sectional view taken along line VB-VB of FIG. 5A;

FIG. 5C is a perspective view showing a configuration of the objective lens actuator of the optical head device of FIG. 1;

FIG. 5D is a view of a state in which a λ/4 wavelength plate 125 of FIG. 5C is detached;

FIG. 6 is an exploded perspective view of the objective lens actuator of FIG. 5A;

FIG. 7A is a perspective view showing a schematic configuration of an optical information device using the optical head device of FIG. 1;

FIG. 7B is a schematic view showing a mechanism of driving the optical head device in the optical information device of FIG. 7A;

FIG. 7C is a block diagram showing a schematic configuration of a drive system of the optical information device of FIG. 7A;

FIG. 8 is a schematic view showing a configuration of a computer mounted with the optical information device of FIG. 7A;

FIG. 9A is a view showing a schematic configuration of an optical disc player mounted with the optical information device shown in FIG. 7A;

FIG. 9B is a view showing a schematic configuration of an optical disc recorder mounted with the optical information device shown in FIG. 7A;

FIG. 10 is a view showing a schematic configuration of an optical system of an optical head device of the prior art;

FIG. 11 is a view showing a schematic configuration of an optical system of an optical head device of another example of the prior art; and

FIG. 12 is a frame format view showing a schematic configuration of only the components of the optical system of the optical head device of FIG. 11.

### EXPLANATION OF NUMERALS

10 actuator base
11 suspension unit
12 opening
13 base plate
14 magnet part
15 magnet supporting portion
15a, 15b fixed part
20 suspension holder
22 suspension wire
30 movable body
32 coil
33a, 33b lens barrel
34 hologram element
35 objective lens holder
100 optical head device
101 optical base
110 guide rail
111 engagement part
120 first optical system
121 first light source
122 polarization beam splitter
123 collimator lens
124 rising prism
125 λ/4 wavelength plate
126 objective lens
127 photodetector
128 drive motor
129 light beam
140 second optical system
141 second laser unit
142 third laser unit
143 collimator lens
144 objective lens
145 half mirror
148, 149 light beam
164 spindle motor
200, 201, 202 optical disc

### BEST MODE FOR CARRYING OUT THE INVENTION

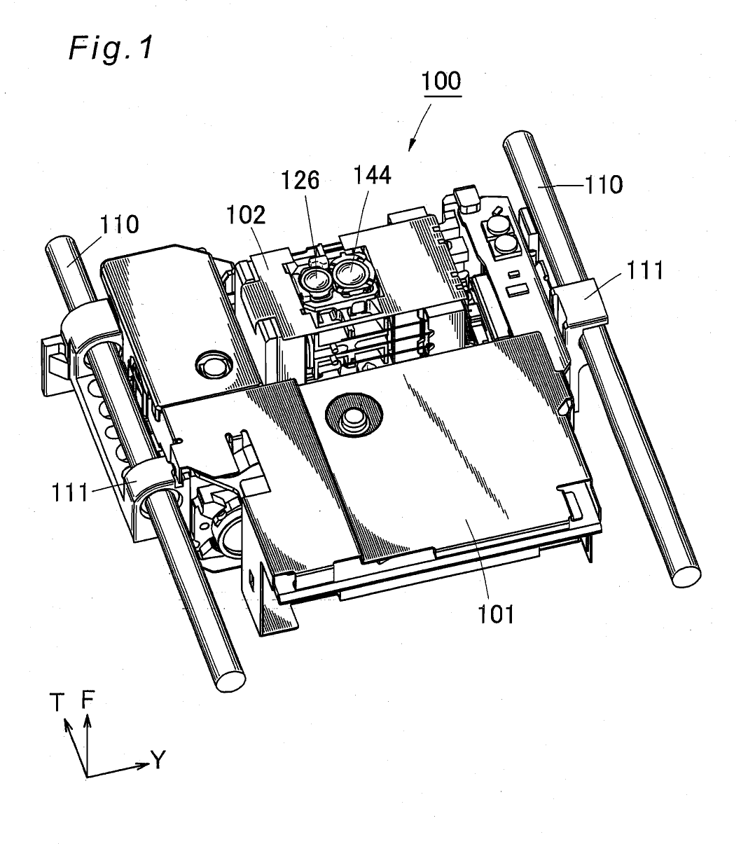

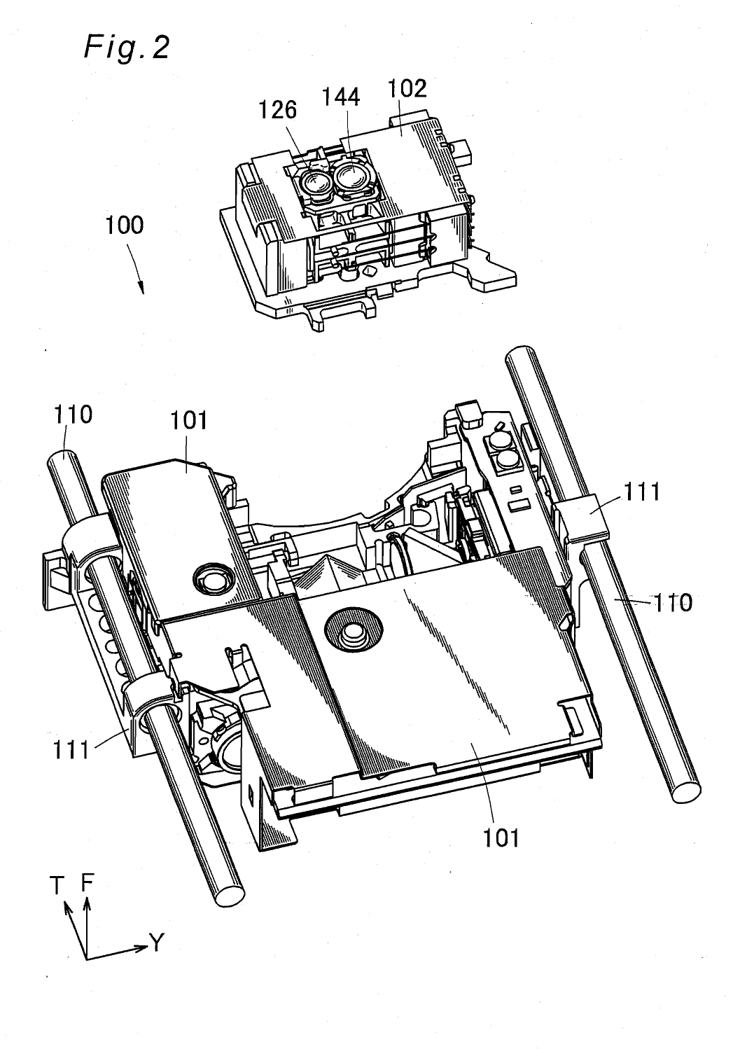

Before the description of the present invention proceeds, it is to be noted that like parts are designated by like reference numerals throughout the accompanying drawings. An optical head device according to one embodiment of the present invention will be described below with reference to the drawings. First, the configuration of the optical head device will be described using FIG. 1 and FIG. 2.

Before describing the configuration of the optical head device, the definition of the coordinate axis in the present optical head device will be defined. The T-axis is a direction perpendicular to the optical axis of the objective lens and substantially perpendicular to a track groove extending direction of the optical disc, or the direction (tracking direction) of moving the optical head device when recording and reproducing the inner circumference or the outer circumference of the optical disc. The F axis is the optical axis direction of the objective lens, that is, the focusing direction. The Y axis is a direction perpendicular to the T axis, and is a direction substantially parallel to the track groove extending direction of the optical disc at the position of the objective lens.

FIG. 1 is a perspective view showing an outer appearance configuration of an optical pickup according to an embodiment of the present invention, and FIG. 2 is an exploded perspective view of the optical pickup of FIG. 1. An optical head device 100 includes an optical base 101, and an objective lens actuator 102 fixed on the upper side in the figure of the optical base 101. The optical base 101 is engaged to a set of guide rails 110 by an engagement part 111 positioned at both ends in the Y axis direction, and is configured to be movable in the tracking direction along the guide rail 110.

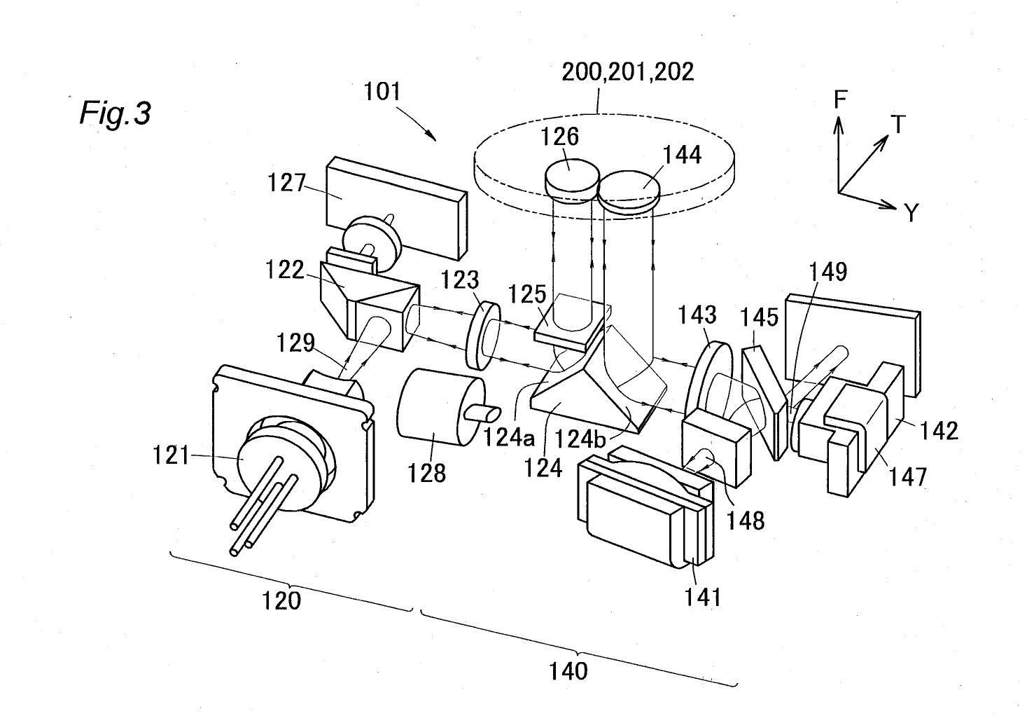

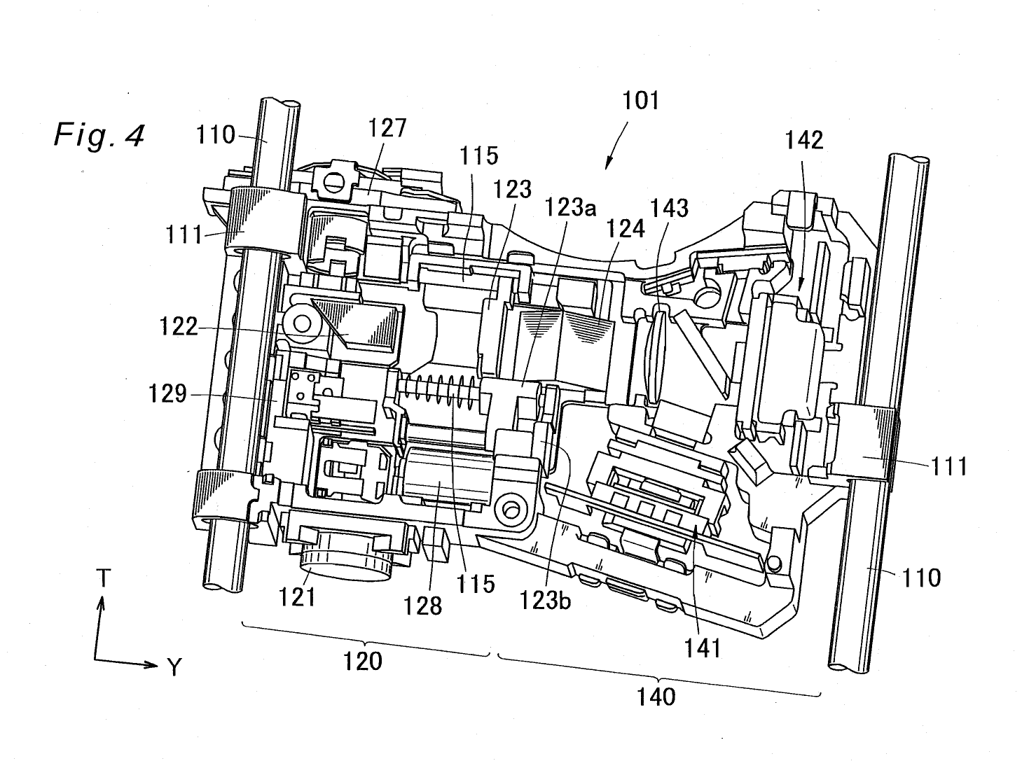

FIG. 3 is a schematic view showing in frame format a configuration of an optical system of the optical head device of FIG. 1. FIG. 4 is a view showing an internal configuration of the optical base used in the optical head device. Each member configuring the optical system of the optical head device is mounted on the optical base 101 and the objective lens actuator 102.

The optical head device 100 according to the present embodiment includes a first optical system 120 and a second optical system 140. The first optical system 120 is an optical system for performing reading and writing of a next generation optical disc 200 such as Blu-ray disc and HD-DVD, and the second optical system 140 is an optical system for performing reading and writing of DVD 201 and CD 202.

The first optical system 120 will be described first. In the first optical system 120, a first light source 121 emits a light beam 129 of wavelength 405 nm. The light beam 129 emitted from the first light source 121 reaches a collimator lens 123 with an optical path bent by a polarization beam splitter 122. The light beam 129 transmitted through the polarization beam splitter 122 is a linear polarized light, and has a divergence degree converted by the collimator lens 123. The relevant light beam has the optical axis folded to a direction perpendicular to the optical disc 200 of high recording density by a first inclined surface 124a of a rising prism 124 having a substantially triangular cross section serving as an example of a folding mirror. The light beam folded by the rising prism 124 is converted to a circular polarized light by passing through a λ/4 wavelength plate 125 serving as an example of a wavelength plate. Thereafter, the light beam 129 is converged on a recording surface of the optical disc 200 by an objective lens 126, thereby forming an optical spot.

A first light beam reaching the optical disc 200 is reflected by a recording layer of the optical disc 200 at a reflectivity corresponding to the state of the recording layer. The first light beam reflected by the recording layer of the optical disc 200 is again transmitted through the objective lens 126, and reached to the λ/4 wavelength plate 125. The light beam reaching the λ/4 wavelength plate 125 is converted to a linear polarized light orthogonal to the forward path (i.e., linear polarized light of the light beam exit from the collimator lens 123 to the rising prism 124) when passing through the λ/4 wavelength plate 125. Subsequently, the light beam is transmitted through the collimator lens 123, and reflected towards the polarization beam splitter 122 by the first reflecting surface 124a of the rising prism 124. The light beam has a polarizing direction different from that of the light beam of forward path, and thus is reflected by the polarization beam splitter 122, and entered to a photodetector 127. In the photodetector 127, the light beam is photoelectric converted by the photodetector 127, and an electric signal for obtaining information signal, and servo signal (focus error signal for focus control, tracking signal for tracking control) is taken out.

The objective lens 126 used in the first optical system 120 has a numerical aperture of NA 0.85 or larger. Since the numerical aperture is large, spherical aberration significantly produces with respect to the thickness of a transparent base material from the surface to which the light enters the optical disc to the information recording surface when performing recordation or reproduction on the optical disc 200. In the present embodiment, the collimator lens 123 is moved in the optical axis direction of the collimator lens 123 to change the divergence converging degree of the light from the collimator lens 123 towards the objective lens 126. When the divergence converging degree of the light entering the objective lens 126 changes, the spherical aberration changes, and the spherical aberration caused by the difference in base material thickness is corrected using this fact. The optical base 101 includes a drive device with a drive motor 128 as a mechanism for moving the collimator lens 123 in the optical axis direction of the collimator lens 123. Specifically, a stepping motor, a brushless motor, and the like may be used for the drive motor 128. As shown in FIG. 4, a holder 123a for holding the collimator lens 123, and a drive mechanism 123b for transmitting the drive power of the drive motor 128 to the holder 123a are arranged on the optical base 101. The holder 123a for holding the collimator lens 123 is supported by two guide shafts 115 extending in the optical axis direction of the collimator lens, and the collimator lens moves along the guide shaft 115. The holder 123a is supported by the guide shaft 115 while being biased by a spring to reduce bumpiness when moving along the guide shaft 115. The lens holder 123a and the collimator lens 123 may be integrally molded to reduce the number of parts.

Two lenses including a concave lens and a convex lens may be combined as a variant of the collimator lens 123. If the collimator lens 123 is configured by two lenses, only one of the two lenses may be moved when moving the collimator lens 123 in the optical axis direction thereof to correct the spherical aberration.

The second optical system 140 will now be described. A second laser unit 141 is used as a second light source (e.g., red light source) in the second optical system 140. The second laser unit 141 is a member in which a light source for emitting the laser light and a photodetector for detecting the laser light are integrally configured. A light beam 148 emitted from the second laser unit 141 reaches a half mirror 145. The light beam 148 is folded by the half mirror 145, has the parallelism converted (e.g., to substantially parallel light) by the collimator lens 143, and is guided to the rising prism 124. The rising prism 124 folds the optical axis in a direction perpendicular to the optical disc 201 (e.g., DVD) of low recording density by means of a second inclined surface 124b. An objective lens 144 converges the light beam 148 on the recording surface of the optical disc 201, thereby forming an optical spot. The light beam reflected by the recording surface of the optical disc 201 at a reflectivity corresponding to the state of the recording layer follows the original optical path in the opposite direction until reaching the second laser unit 141 or the photodetector. The light beam 148 is photoelectric converted by the second laser unit 141, and an electric signal for obtaining information signal, and servo signal (focus error signal for focus control, tracking signal for tracking control) is obtained. In the present embodiment, the second laser unit 141 in which the light source and the photodetector are integrated is used, and thus the optical head device can be miniaturized and thinned, and stability can be achieved.

Furthermore, a third laser unit 142 or a third light source (e.g., red light source) is arranged to perform reproduction or recordation of the third optical disc 202 (e.g., compact disc: CD) having lower recording density than the two types of optical discs described above. The third laser unit 142 is a member in which a light source for emitting the laser light and a photodetector for detecting the laser light are integrally configured. A light beam 149 emitted from the third laser unit 142 transmits through the half mirror 145, has the parallelism converted (e.g., to substantially parallel light) by the collimator lens 143, and is guided to the rising prism 124. The rising prism 124 folds the optical axis in a direction perpendicular to the optical disc 202 (e.g., CD) of low recording density by a surface different from the surface reflecting the first light beam. The objective lens 144 converges the light beam 148 on the recording surface of the optical disc 201, thereby forming an optical spot. The light beam reflected by the recording surface of the optical disc 202 at a reflectivity corresponding to the state of the recording layer follows the original optical path in the opposite direction until reaching the third laser unit 142 or the photodetector. The light beam 149 is photoelectric converted by the third laser unit 142, and an electric signal for obtaining information signal, and servo signal (focus error signal for focus control, tracking signal for tracking control) is obtained. In the present embodiment, the third laser unit 142 in which the light source and the photodetector are integrated is used, and thus the optical head device can be miniaturized and thinned, and stability can be achieved.

As described above, in the first optical system 120, the light source 121 for emitting the laser light and the photodetector 127 for detecting the laser light reflected by the optical disc 200 are configured by separate members, and thus the optical path needs to be differed for the forward path and the backward path by the polarization beam splitter 122. The λ/4 wavelength plate 125 is arranged as a member for changing the optical path of the laser light, so that the optical path can be differed by changing the polarization of the laser light when passing through the λ/4 wavelength plate 125. In the second optical system, on the other hand, the light source for emitting the laser light and the photodetector for detecting the laser light reflected by the optical disc 201, 202 arranged for the respective optical disc 201, 202 are united, and are configured as one member as the second laser unit 141 and the third laser unit 142, respectively. Thus, the optical path does not need to be differed for the forward path and for the backward path, and the polarization of the laser light does not need to be changed for the forward path and the backward path. Therefore, the λ/4 wavelength plate does not need to be arranged in the second optical system 140.

In FIG. 3 and FIG. 4, the cross section of the rising prism 124 is triangular, but the vertex (edge line of the prism as a whole) may be chamfered to prevent chipping (crack) of the rising prism. The cross section is indicated herein as substantially triangular in view of this relevant case.

In the present embodiment, the objective lenses 126, 144 and the λ/4 wavelength plate 125 of each member configuring the first and second optical systems 120, 140 are arranged in the objective lens actuator 102. Other members excluding the objective lenses 126, 144 and the λ/4 wavelength plate 125 are arranged on the optical base 101.

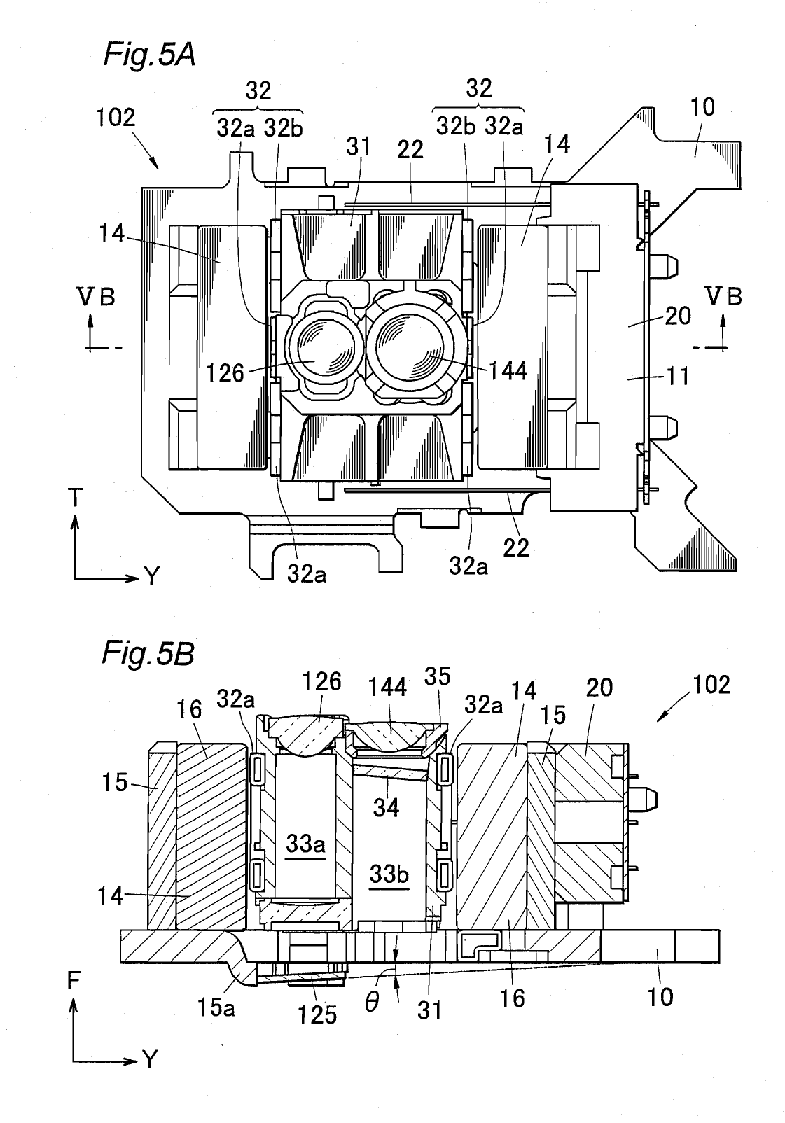

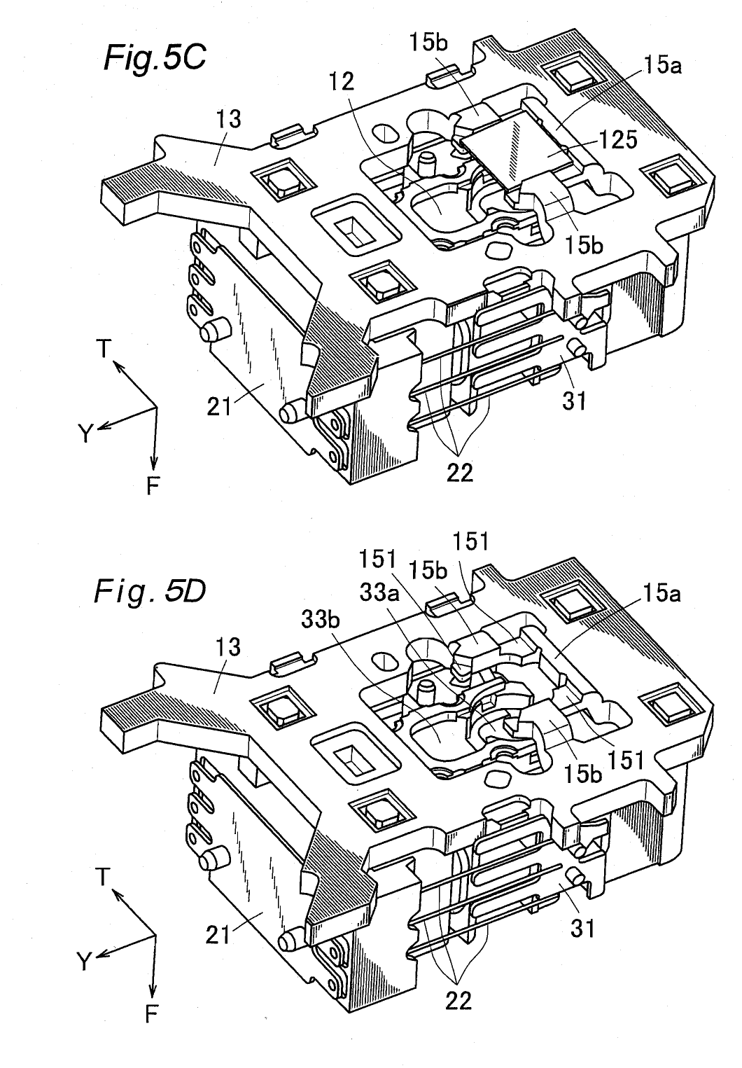

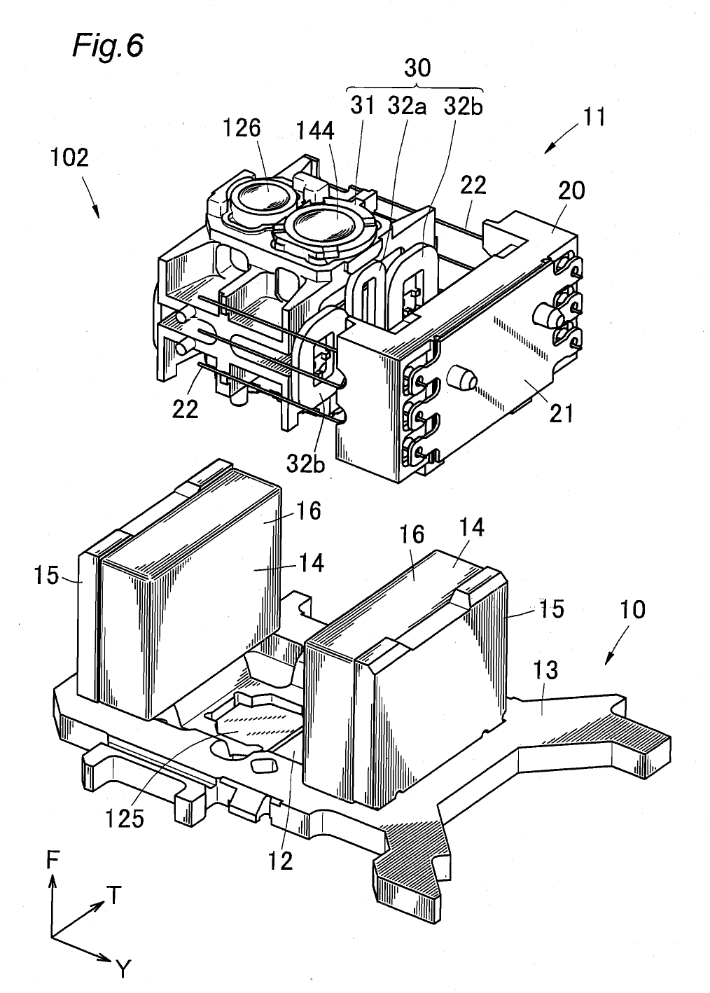

As shown in FIG. 5A, FIG. 5B, FIG. 5C, FIG. 5D, and FIG. 6, the objective lens actuator 102 includes an actuator base 10 and a suspension unit 11.

The actuator base 10 has a pair of magnet parts 14 arranged in parallel so as to face each other in the Y axis direction with an opening 12 in between on a base plate 13 including the opening 12 for transmitting the laser light reflected in the F axis direction by the rising prism 124. The magnet part 14 includes a magnet supporting portion 15 arranged upstanding on the base plate 13, and a magnet 16 arranged on the surface on the opening 12 side of the magnet supporting portion 15. A movable body 30 of the suspension unit 11 is arranged between the pair of magnet parts 14, and position adjustment of the movable body 30 of the suspension unit 11 can be performed by supplying current to a coil 32 of the movable body 30 as hereinafter described.

Fixed parts 15a, 15b for holding the λ/4 wavelength plate 125 are arranged on the base plate 13. The fixed parts 15a, 15b hold the λ/4 wavelength plate 125 so as to cover the surface of one portion of the opening 12 of the base plate 13 such that the λ/4 wavelength plate 125 is arranged only in the first optical system 120. The fixed parts 15a, 15b hold the λ/4 wavelength plate 125 so as to project out towards the rising prism 124 side from the surface on the optical base 101 side of the actuator base 10.

As shown in FIG. 5C and FIG. 5D, the fixed parts 15a, 15b are hook nail shaped members arranged at three locations of the edges of the opening 12 of the base plate 13 so as to hold the λ/4 wavelength plate 125 from three sides. The fixed parts 15a, 15b are arranged with a mounting part 151 for mounting the λ/4 wavelength plate 125, where the attachment direction of the λ/4 wavelength plate 125 can be fixed by mounting the λ/4 wavelength plate 125 on the mounting part 151.

The λ/4 wavelength plate 125 is fixed so as to have a tilt angle θ of one degree to ten degrees, and preferably of two degrees to six degrees with respect to the surface of the base plate 13 of the actuator base 10. In the present embodiment, the tilt angle θ is formed to three degrees. In the present embodiment, a configuration of holding the λ/4 wavelength plate 125 using the hook nail shaped fixed parts 15a, 15b arranged at three sides of the edges of the opening 12 is adopted, so that the angle precision of the λ/4 wavelength plate 125 can be enhanced.

The λ/4 wavelength plate 125 is fixed in a tilted manner for the following reasons. When one part of the light reflected by the rising prism 124 is reflected at the surface of the λ/4 wavelength plate 125 without reaching the optical disc 200 and reaches the photodetector 127, the reading of information at the photodetector 127 is influenced. Therefore, the wavelength plate may be tilted so that the light reflected at the surface of the λ/4 wavelength plate 125 does not reach the photodetector 127, thereby preventing such problem. If the tilt becomes greater than or equal to ten degrees, a space in the optical path direction for arranging the λ/4 wavelength plate 125 needs to be larger, and the distance between the objective lens and the rising prism 124 becomes longer. As a result, the objective lens actuator 102 becomes large in the F axis direction. If smaller than one degree, it is within the tilt range of when fixing the objective lens actuator 102 to the optical vase 101 in time of skew adjustment of the objective lenses 126, 144. Thus, the wavelength plate 125 may be arranged in a direction orthogonal to the optical path, in which case, the above problem may arise.

In the present embodiment, the λ/4 wavelength plate 125 is arranged in the objective lens actuator 102 and is not arranged between the polarization beam splitter 122 and the rising prism 124, where the entire region of the distance between the polarization beam splitter 122 and the rising prism 124 may be used as a movement region of the collimator lens 123. Therefore, the movement range of the collimator lens 123 can be increased without enlarging the optical pickup device itself, and consequently, the correction range of the spherical aberration can be increased.

The suspension unit 11 includes the movable body 30 configured to be movable with respect to the actuator base 10, and a suspension holder 20 for movably supporting the movable body. The movably body 30 is supported by six suspension wires 22 extending from the suspension holder 20, and is movable in a direction the six suspension wires 22 bend with respect to the suspension holder 20, that is, the direction orthogonal to the extending direction of the six suspension wires 22. The suspension unit 11 is assembled to the actuator base 10 so that the movable body 30 is positioned between the magnets 16, and the suspension holder 20 is positioned on the outer side with respect to the magnet part 14.

The movable body 30 includes two lens barrels 33a, 33b extending in the F direction. When the suspension unit 11 is assembled to the actuator base 10, the lens barrel 33a of the movable body 30 is positioned on the upper side of the wavelength plate 125. The objective lens 126 is arranged in the lens barrel 33a of the first optical system 120, and the objective lens 144 is arranged in the lens barrel 33b of the second optical system 140. A hologram element 34 is arranged in the lens barrel 33b of the second optical system 140, so that one part of the laser light reflected by the optical disc of the second optical system 140 is divided through diffraction, and a focus error signal or a tracking error signal is generated.

The objective lens 144 for the second optical system 140 is fixed to the movable body 30 while being fixed to the objective lens holder 35 as shown in FIG. 5B. The objective lens holder 35 is configured to have the surface on the lens barrel 33b side tapered so that the attachment angle can be adjusted when fixing to the lens barrel 33b. The configuration in which the fixing direction of the objective lens 144 and the movable body 30 can be adjusted is adopted for the following reasons. When fixing two objective lenses 126, 144 to the movable body 30, fine tuning in the optical axis direction of the objective lenses 126, 144 becomes necessary in the two optical systems 120, 140. Thus, in the present embodiment, fine tuning of both optical systems is achieved by having the objective lens 126 for the first optical system 120 as a reference, and fine tuning the objective lens 144 for the second optical system 140.

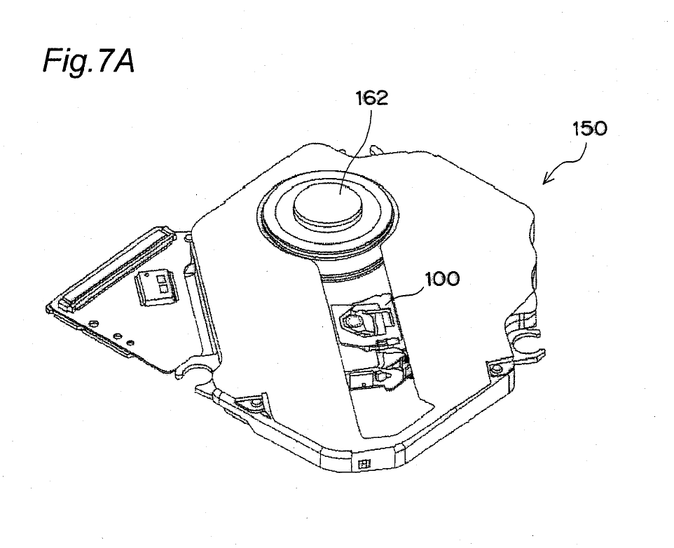

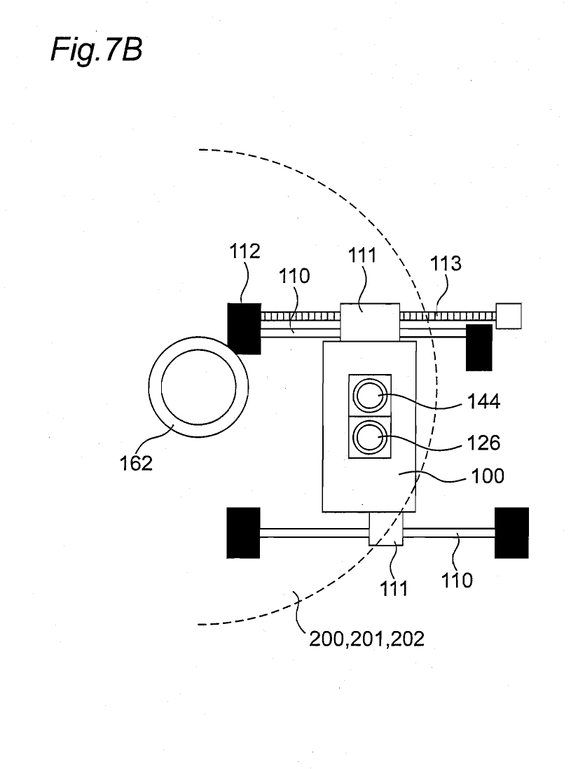

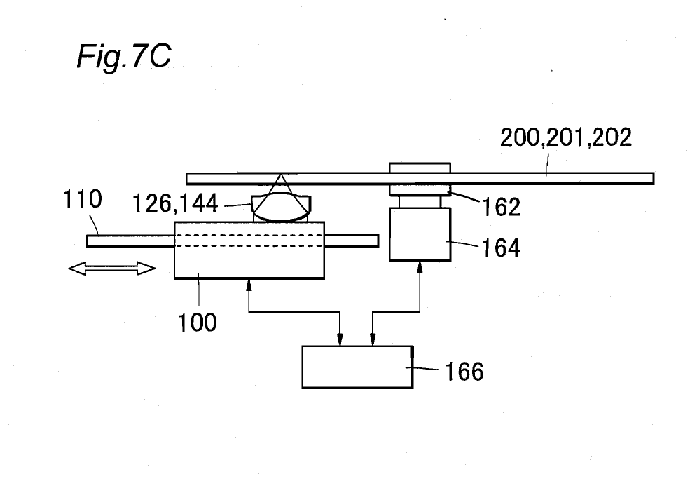

The objective lens 126 of the first optical system 120 and the objective lens 144 of the second optical system are held by the movable body 30 while being lined substantially parallel to the Y direction, that is, the track groove extending direction of the optical disc. If the two objective lenses are lined in a direction orthogonal to the track groove extending direction, the non-used objective lens on the inner side might interfere with a spindle motor 164 (see FIG. 7A) for rotating the optical discs 200, 201, 202, or the lens on the outer side might interfere with the exterior of the equipment when moved to the outermost periphery or the innermost periphery of the optical disc. If the objective lenses 126, 144 are lined in the Y direction, compatibility with different types of discs becomes possible without the optical head device hitting the motor etc. for rotating the optical disc.

In the movable body 30, three coils 32 for adjusting the position of the movable body 30 are arranged at the surface facing the magnet 16 when the suspension unit 11 is assembled to the actuator base 10. In other words, since the magnet of the magnet part 14 arranged in the actuator base 10 and the coil 32 arranged in the suspension unit 11 are arranged facing each other, the movable body 30 can be moved by flowing current to the relevant coil.

The power is supplied to the coil 32 through the suspension wire 22. The coil 32 is arranged with a coil 32a for focusing direction (direction perpendicular to the surface of the optical disc) and a coil 32b for tracking direction (radial direction of the disc), and fine turning of the position in the focusing direction and the tracking direction is performed by supplying current to the coil 32 through the suspension wire 22.

The optical axes on which the light beam 129 and the light beam 148 or the light beam 149 enters the rising prism 124 are desirably parallel to each other. According to such configuration, the two reflecting surfaces 124a, 124b of the rising prism 124 can be symmetrically formed, so that the incidence angle to the objective lens is parallel to the optical axis of the objective lens. Since the two reflecting surfaces 124a, 124b of the rising prism 124 are configured symmetrically, the rising prism 124 can be more easily formed, and can be formed at low cost.

One example of an optical information device using the optical head device of FIG. 1 will now be described. FIG. 7A is a perspective view showing a schematic configuration of an optical information device using the optical head device of FIG. 1. FIG. 7B is a schematic view showing a mechanism for driving the optical head device in the optical information device of FIG. 7A, and FIG. 7C is a block diagram showing a schematic configuration of a drive system of the optical information device of FIG. 7A.

An optical information device 150 is mounted movably in the tracking direction of the optical disc as shown in FIG. 7A. As shown in FIG. 7B, the optical head device 100 is supported by two guide rails 110 arranged extending in the tracking direction of the optical disc, and is connected to a lead screw 113 arranged parallel to the guide rail 110 on one side. The lead screw 113 rotates with the axis as the center by a motor 112, and the optical head device 100 moves in the tracking direction by the rotation of the lead screw 113.

In FIG. 7A, FIG. 7B, and FIG. 7C, the optical discs 200, 201, 202 are mounted on a turn table 162, and rotated by a motor 164. The optical head device 100 of FIG. 1 is roughly moved up to the position of the track where the desired information exists of the optical disc.

The optical head device 100 sends a focus error (focus error) signal or a tracking error signal to an electric circuit 166 in correspondence to a position relationship with the optical discs 200, 201, 202. In response to such signal, the electric signal 166 sends a signal for driving the lens actuator to the optical head device 100 to finely move the objective lenses 126, 144. According to such signal, the optical head device 100 performs focus control and tracking control on the optical discs 200, 201, 202, and the optical head device 100 performs reading or writing (recording) and erasing of information.

The optical information device uses the optical head device of FIG. 1 as the optical head device, and thus can respond to a plurality of optical discs having different recording densities with a single optical head device.

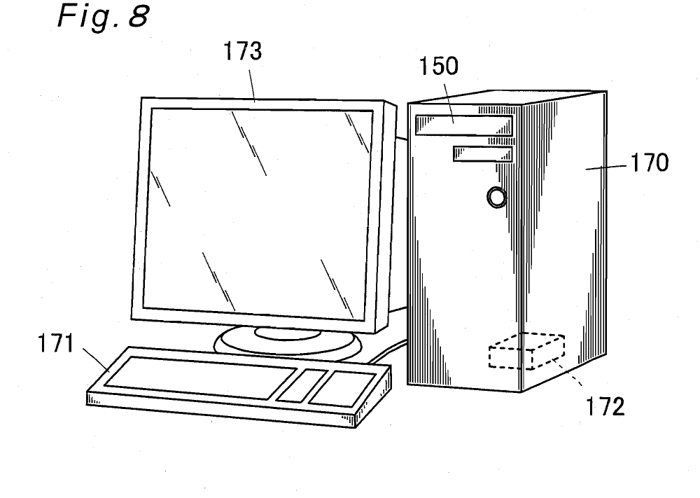

The optical information device shown in FIG. 7A can be mounted on various devices. A computer, an optical disc player, and an optical disc recorder mounted with the optical information device of FIG. 7A stably record or reproduce different types of optical disc, and thus can be used in wide range of applications. FIG. 8 is a schematic view showing a configuration of a computer mounted with the optical information device of FIG. 7A.

In FIG. 8, a computer 170 equipped with the optical information device 150 of FIG. 7A, an input device 171 such as keyboard, mouse, and touch panel for inputting information, a calculation device 172 such as central processing unit (CPU) for performing calculation based on the information input from the input device 171, information read out from the optical information device 150, and the like, and an output device 173 such as Braun tube and liquid crystal display device, printer, or the like for displaying information such as result of calculation by the calculation device is configured.

The computer 170 may be mounted with wired or wireless input/output terminal for retrieving information to be recorded on the optical information device 150, or outputting to the outside information read out by the optical information device 150. Thus, the computer can transmit and receive information with network, that is, a plurality of equipments such as computer, telephone, and television tuner, and can be used as an information server (optical disc server) shared by the plurality of equipments. Since different types of optical discs can be stably recorded or reproduced, it can be used in a wide range of applications.

Furthermore, a changer 331 for inserting and retrieving a plurality of optical discs with respect to the optical information device 150 may be arranged to obtain an effect of recording/accumulating great amount of information.

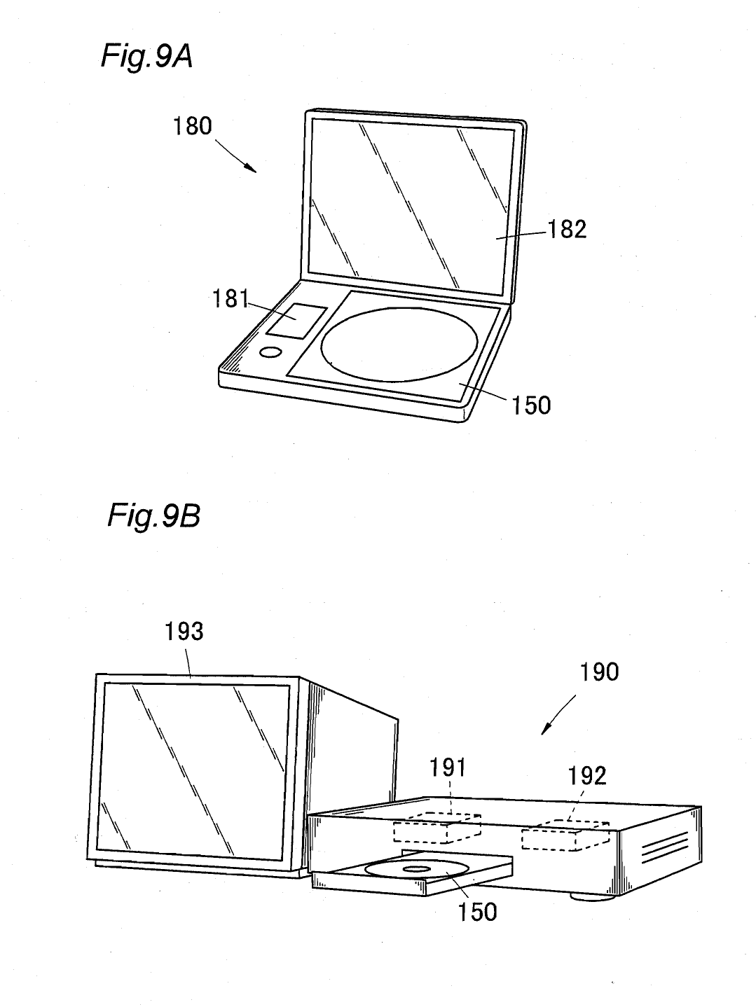

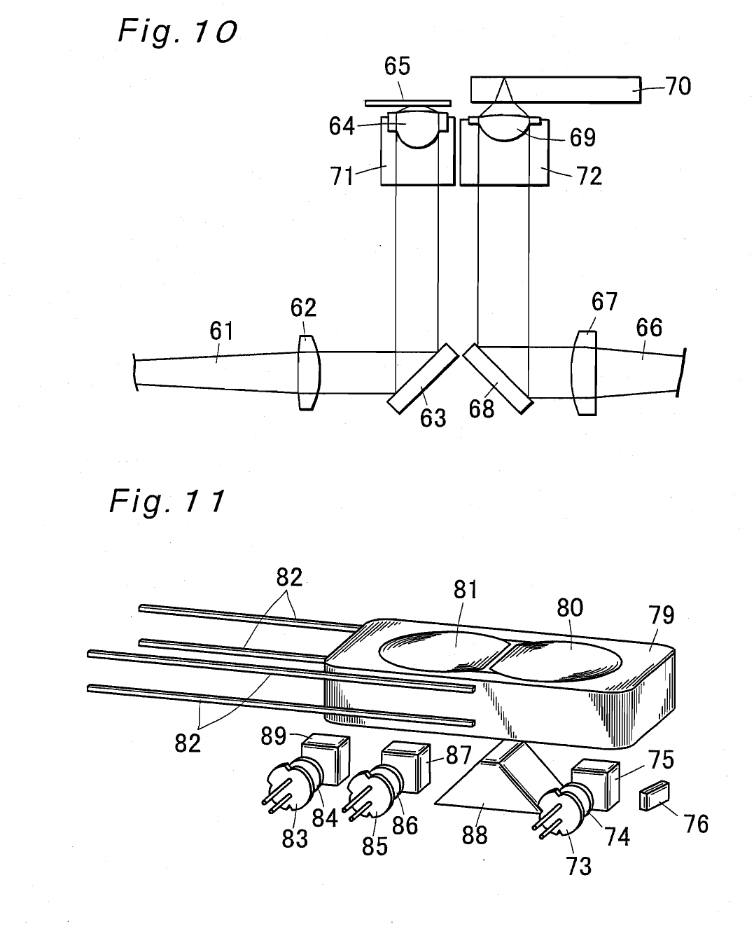

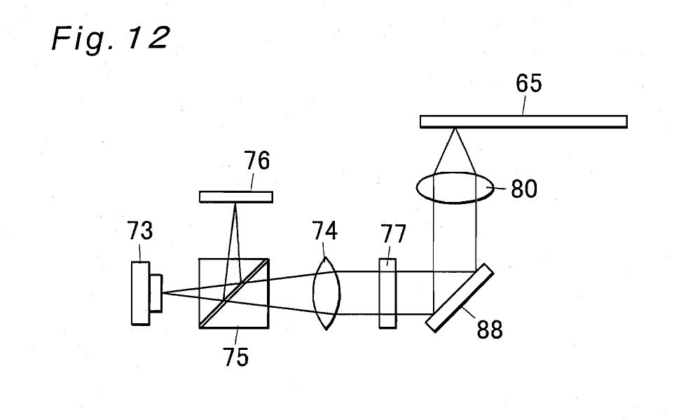

FIG. 9A shows a schematic configuration of an optical disc player mounted with the optical information device shown in FIG. 7A. In FIG. 9A, an optical disc player 180 including the optical information device 150 of FIG. 7A and an information-image conversion device (e.g., decoder 181) for converting the information signal obtained from the optical information device to an image is configured. This configuration can also be used in a car navigation system. A display device 182 such as a liquid crystal monitor may be added.

FIG. 9B shows a schematic configuration of an optical disc recorder mounted with the optical information device shown in FIG. 7A. In FIG. 9B, an optical disc recorder including the optical information device 150 of FIG. 7A and an image-information conversion device (e.g., encoder 192) for converting the image information to information to be recorded on the optical disc by the optical information device is configured. An information-image conversion device (decoder 191) for converting the information signal obtained from the optical information device to an image is also desirably mounted to reproduce the already recorded portion. An output device 193 such as Braun tube and liquid crystal display device for displaying information may be arranged.

In the equipment using the above-mentioned optical information device 150 of FIG. 7A, the output device is shown, but obviously, a product form having an output terminal arranged in such device and having an output device as a different configuration may be realized. The input device is not shown in each device, but a product form also including the input device such as keyboard, touch panel, mouse, remote control device, and the like is also possible, or the input device may be a different configuration and only the input terminal may be arranged.

The present invention is not limited to the above embodiments, and may be implemented in various other modes.

Arbitrary embodiments of the various embodiments described above may be appropriately combined to obtain the respective effects.

### INDUSTRIAL APPLICABILITY

The optical head device according to the present invention can perform recordation and reproduction with respect to a plurality of types of optical discs having different base material thickness or correspondence wavelength, recording density, and the like, and the optical information device using such optical head device can handle optical discs of a great number of standards such as CD, DVD, BD, and the like. Therefore, the optical information device can be applied and developed in various systems for recording and reproducing information such as computer, optical disc player, optical disc recorder, car navigation system, edit system, optical disc server, and AV component.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1-12. (canceled)

13. An optical head device comprising:
a light source for emitting a light of a predetermined wavelength;
a collimator lens for changing a divergence degree of the light emitted from the light source;
a folding mirror for folding a direction of the light emitted from the light source which divergence degree is changed by the collimator lens;
an objective lens for converging the light folded by the folding mirror on a recording surface of an optical disc;
a photodetector for receiving the light converged on the recording surface of the optical disc by the objective lens and reflected at the recording surface of the optical disc, and converting to an electric signal;
a wavelength plate, arranged between the folding mirror and the objective lens, for polarizing the light reflected by the folding mirror; and
an optical path adjustment unit for guiding the light emitted from the light source to the collimator lens and guiding the light reflected at the recording surface of the optical disc to the photodetector according to the polarization of the light transmitted through the wavelength plate; the optical head device further comprising:
an optical base for holding the light source, the collimator lens, the folding mirror, and the photodetector;
an actuator base, arranged adjacent to the optical base, for holding the wavelength plate so as to cover an opening through which the light reflected by the folding mirror transmits, and
a suspension unit, supported to be movable in an optical axis direction of the objective lens and a track direction of the optical disc with respect to the actuator base, for holding the objective lens at a position enabling the light reflected by the folding mirror to reach the objective lens.

14. The optical head device according to claim 13, wherein
the optical path adjustment unit is configured by a polarization beam splitter, arranged between the light source and the collimator lens, for polarizing the light emitted from the light source; and
the wavelength plate is configured by a ¼ plate for polarizing the light reflected by the folding mirror to a circular polarized light.

15. The optical head device according to claim 13, wherein the actuator base includes a fixed part, arranged projecting towards the optical base side, for fixing the wavelength plate.

16. The optical head device according to claim 15, wherein the fixed part fixes the wavelength plate so as to be tilted at an angle of one to ten degrees with respect to the actuator base.

17. The optical head device according to claim 15, wherein
the fixed part is configured by a plurality of hook nail shaped members integrally formed in the actuator base and arranged extending from an edge of the opening; and
each hook shaped member includes a mounting part for mounting the wavelength plate, and fixes the wavelength plate by gripping the periphery of the wavelength plate at a plurality of locations.

18. The optical head device according to claim 13, wherein the suspension unit includes a suspension holder fixed to the actuator base, and a movable body for holding the objective lens, the movable body being supported by a suspension wire extending from the suspension holder and driven by a signal provided through the suspension wire.

19. The optical head device according to claim 13, wherein the light source is a semiconductor laser which emits light in a blue wavelength region.

20. An optical information device comprising:
the optical head device according to claim 13;
a motor for rotating an optical disc; and
an electric circuit for receiving a signal obtained from the optical head device, and controlling and driving the motor and the optical head device based on the signal.

21. A computer comprising:
the optical information device according to claim 20;
an input device for inputting information;
a calculation device for performing calculation based on information input from the input device and information reproduced from the optical information device; and
an output device for displaying or outputting information reproduced by the optical information device and result calculated by the calculation device.

22. An optical disc player comprising:
the optical information device according to claim 20; and
an information-image decoder for converting an information signal obtained from the optical information device to an image.

23. A car navigation system comprising:
the optical information device according to claim 20; and
an information-image decoder for converting an information signal obtained from the optical information device to an image.

24. An optical disc recorder comprising:
the optical information device according to claim 20; and
an image-information encoder for converting image to information to be recorded by the optical information device.

25. An optical disc server comprising:
the optical information device according to claim 20; and
an input/output terminal for transmitting and receiving information with outside.
